(19) United States
(12) Patent Application Publication
(10) Pub. No.: US 2004/0135974 A1
(43) Pub. Date: Jul. 15, 2004

(54) System and architecture for displaying three dimensional data

(76) Inventors: Gregg E. Favalora, Cambridge, MA (US); Joshua Napoli, Lexington, MA (US); Wou-Suk Chun, Cambridge, MA (US); Cameron Lewis, Winchester, MA (US)

Correspondence Address: CONTOR COLBURN LLP, 55 Griffin Road South, Bloomfield, CT, 06002, US

(21) Appl. No.: 10/688,595

(22) Filed: Oct. 17, 2003

Related U.S. Application Data
(60) Provisional application No. 60/419,362, filed on Oct. 18, 2002.

(51) Int. Cl. G03B 21/00

(52) U.S. Cl. 353/10

(57) ABSTRACT

A system for displaying graphical information in three dimensions. The system includes a host device executing an application for generating graphical information in a spatial transport protocol. Rendering hardware generates three-dimensional display data and a frame buffer stores the three-dimensional display data. A spatial display displays the three-dimensional display data. A spatial transport protocol interpreter receives the graphical information in the spatial transport protocol and controls operation of the rendering hardware and the frame buffer in response to the graphical information in the spatial transport protocol. An architecture for displaying graphical information in three-dimensions is also provided.

### CROSS REFERENCE TO RELATED APPLICATIONS

This application claims the benefit of the filing date of U.S. provisional patent application serial No. 60/419,362, filed Oct. 18, 2002, the contents of which are herein incorporated by reference.

### BACKGROUND

Three-dimensional (“3D”) information is used in a variety of tasks, such as radiation treatment planning, mechanical computer-aided design, computational fluid dynamics, and battlefield visualization. As computational power and the capability of sensors improve, the user is forced to comprehend more information in less time. For example, a rescue team has limited time to discover a catastrophic event, map the structure of the context (i.e., a skyscraper), and deliver accurate instructions to team members. Just as an interactive computer screen is better than a paper map, a spatial 3D display offers rescue planners the ability to see the entire scenario at once. The 3D locations of the injured are more intuitively known from a spatial display than from a flat screen, which would require rotating the “perspective view” in order to build a mental model of the situation.

Display technologies now exist which are designed to cope with these large datasets. Spatial 3D displays (e.g., Actuality Systems Inc.'s Perspecta™ Display) create imagery that fills a volume of space—such as inside a transparent dome—and that appears 3D without any cumbersome headwear. One spatial 3D display is described in U.S. Pat. No. 6,554,430 B2, “Volumetric three-dimensional display system.”

It is expected that a variety of spatial displays will come into existence soon. Furthermore, software applications will emerge that will exploit the unique properties of spatial displays. The software applications will need user interfaces, 3D data processing and visualization tools, and compliance with existing software standards like the OpenGL® API from Silicon Graphics, Inc. and the Direct3D® API from Microsoft Corporation. In order to allow every type of display to be compatible with every application, a standard is needed which dictates how (electronically and with what protocol) spatial 3D information is transmitted to the display device.

### BRIEF DESCRIPTION OF THE DRAWINGS

FIG. 1 illustrates an exemplary three-dimensional spatial display.

FIG. 2 diagrams an exemplary architecture of a spatial visualization environment.

FIG. 3 shows an exemplary system for displaying graphical information in an embodiment of the invention.

FIG. 4 shows an exemplary system for displaying graphical information in an alternate embodiment of the invention.

### SUMMARY OF THE INVENTION

An embodiment of the invention is a system for displaying graphical information in three dimensions. The system includes a host device executing an application for generating graphical information in a spatial transport protocol. Rendering hardware generates three-dimensional display data and a frame buffer stores the three-dimensional display data. A spatial display displays the three-dimensional display data. A spatial transport protocol interpreter receives the graphical information in the spatial transport protocol and controls operation of the rendering hardware and the frame buffer in response to the graphical information in the spatial transport protocol.

Another embodiment of the invention is an architecture for displaying graphical information in three-dimensions. The architecture includes an application layer including applications for generating visual object descriptions. An application programming interface (“API”) layer receives the visual object descriptions and generates graphical information. An STP layer converts the graphical information into a spatial transport protocol and generates a stream of the graphical information in the spatial transport protocol. A display layer receives the stream of graphical information in the spatial transport protocol and displays the three-dimensional display data on a three-dimensional spatial display.

### DETAILED DESCRIPTION

In one embodiment, the 3D display contains an embedded processing system and optics that create three-dimensional imagery. The processing system generates graphical information according to a protocol referred to as the spatial transport protocol (STP). The source of graphical information is a spatial visualization environment (SVE), which typically includes the ability to run applications, a 3D graphical user interface (“GUI”) including a 3D pointer, a toolkit of functions, and an API. Together, these generate STP graphical information that is rendered by a 3D display.

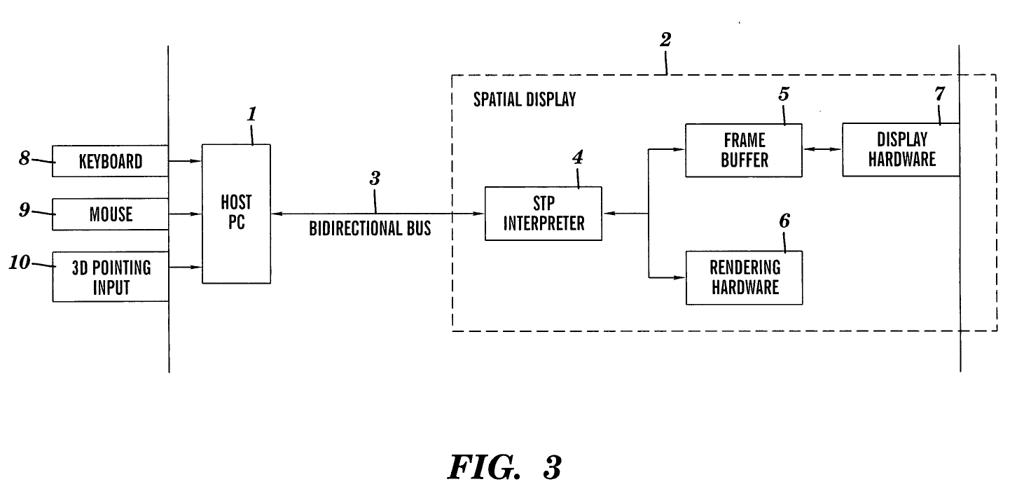

FIG. 3 shows an exemplary embodiment of the invention. A host device 1 (e.g., a personal computer) is connected to a three-dimensional spatial display 2 by an external bus 3. The spatial display 2 is comprised of an STP interpreter 4, which receives commands over the external bus 3. In the embodiment depicted in FIG. 3, the physical bus 3 is defined as a gigabit Ethernet connection. Other physical busses may be used, such as SCSI, Firewire, or a proprietary bus.

The STP interpreter 4 may be implemented by a general purpose processor executing computer program code contained in a storage medium. The STP interpreter 4 operates the frame buffer 5 and rendering hardware 6. The frame buffer 5 controls the display hardware 7. The host device 1 connects to a keyboard 8, mouse 9 and 3D pointing input 10. In this case, most of the rendering computations for the spatial display are done in the display hardware 7 internal to the spatial display 2.

The STP interpreter 4 operates the frame buffer 5 and rendering hardware 6 according to commands that are sent over the external bus 2. The host device 1, and peripherals, provide the spatial visualization environment (SVE) to generate graphical information. The STP interpreter 4 within spatial display 2, forms a part of the SVE and receives STP-formatted graphical information from host device 1. The STP interpreter 4 generates commands to the rendering hardware 6. The rendering hardware 6 computes bitmap images according to the operation of the STP interpreter 4. The bitmap images computed by the rendering hardware 6 are transferred to the frame buffer 5. The frame buffer 5 operates the display hardware 7 in a manner that results in the physical display of images corresponding to the bitmap images stored in the frame buffer 5.

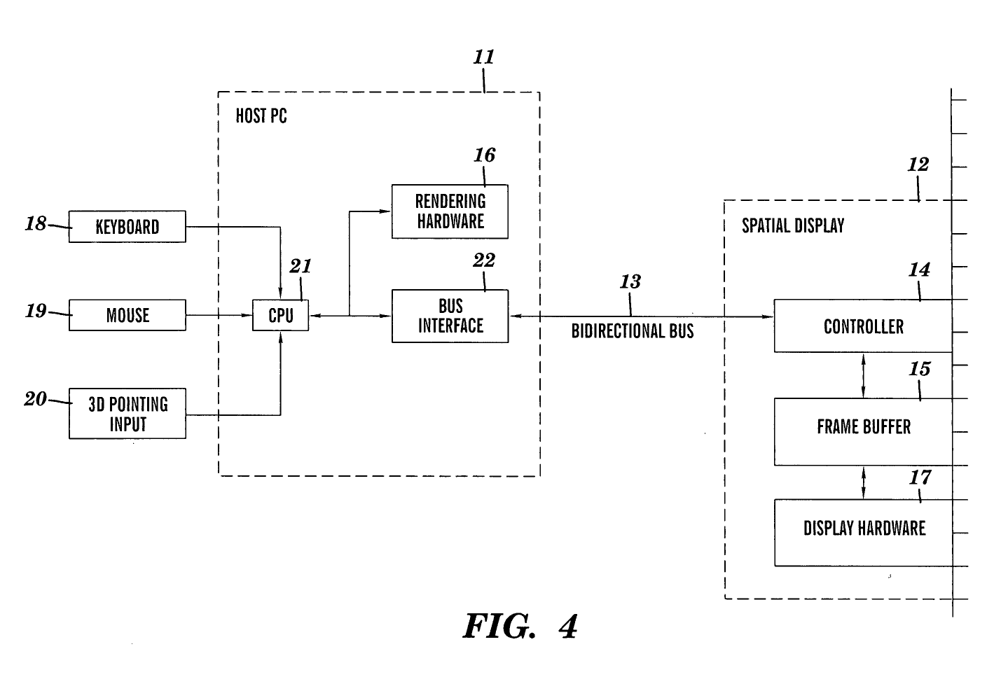

FIG. 4 shows an alternate embodiment of the invention. Once again, a host device 11 is connected to a three dimensional spatial display 12 by a external bus 13. The host device 11 connects to a keyboard 18, mouse 19 and 3D pointing input 20. In this embodiment, the rendering hardware 16 is internal to the host device 11. The spatial display 12 is comprised of a controller 14 (e.g., microprocessor, ASIC, etc.) that operates a frame buffer 15. The frame buffer 15 operates the display hardware 17.

The host device 11 is comprised of a general processor 21, rendering hardware 16, and a bus interface 22. The processor 21 operates the rendering hardware 16 and serves as the STP interpreter. Processor 21 operates in response to a computer program contained in a storage medium accessible by processor 21. The rendering hardware 16 generates bitmaps, which are transferred to the spatial display controller 14 via the external bus 13. The controller 14 loads the bitmaps into the frame buffer 15. The frame buffer 15 operates the display hardware 17 in a manner that results in the physical display of images corresponding to the bitmap images stored in the frame buffer 15.

The systems shown in FIGS. 3 and 4 are exemplary embodiments. It is understood that variations on these embodiments may be implemented. For example, both the host device and the spatial display may contain rendering hardware. In a vector-scanned spatial display, the rendering hardware would generate vector lists instead of bitmaps. Examples of vector-scanned spatial displays are taught in U.S. Pat. No. 3,140,415: “Three-dimensional display cathode ray tube” (R. D. Ketchpel), German Patent No. DE 26 22 802 C2 (R. Hartwig), and B. G. Blundell and W. King, “Outline of a low-cost prototype system to display three-dimensional images,” in IEEE Transactions on Instrumentation and Measurement, 40(4), 792-793 (1991).

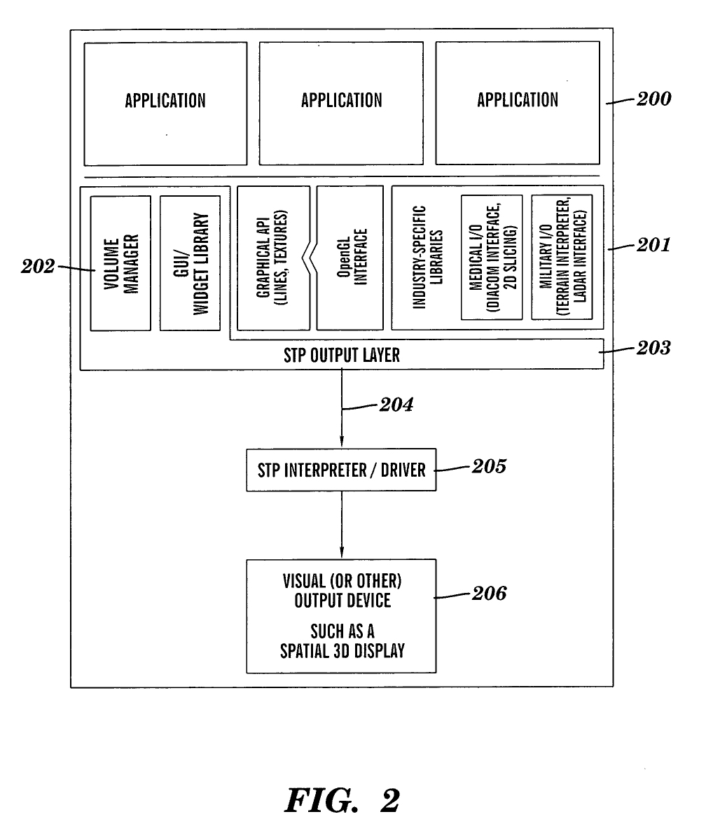

The software architecture of the spatial visualization environment is illustrated in FIG. 2. Native and legacy applications 200 describe visual objects using the API layer 201. Applications that were not written to explicitly take advantage of a spatial 3D display are considered legacy applications. The API layer 201 passes the visual object descriptions to a volume manager 202. The volume manager 202 arbitrates between applications 200 and selectively passes visual object descriptions to the STP output layer 203. The STP output layer 203 transforms the visual object descriptions into a device-independent format. The API layer and STP output layer are implemented by a processor executing one or more software applications.

The native API contains functions that allow all graphical capabilities of the spatial display to be utilized. The native API also comprises commands that render lines, points, triangles and tetrahedrons with specific visual properties. The native API also comprises commands that render a surface whose geometry is specified by a triangle mesh, where the vertices of the mesh are specified directly by the application or as the output of a previous rendering step. The native API also comprises commands that render complex shapes, composed of one or more objects. The native API also comprises commands that load bitmaps into memory accessible to rendering hardware. The native API also comprises commands that load bitmaps into memory accessible to rendering hardware generated by previous rendering commands. The native API also comprises commands that load specifications of procedures into memory accessible to rendering hardware. The native API also comprises commands that render objects, whether defined by commands or defined by bitmap image, a procedure loaded by command, or by a combination of bitmap images and a procedure.

In the embodiment depicted in FIG. 3, an STP-formatted stream of graphical information 204 is transmitted over an external bus 3 to an STP interpreter 205. The STP interpreter 205 uses the rendering hardware 6 to generate bitmap images according the visual objects described by the STP stream 204. The bitmap objects are transferred 206 to the Frame Buffer 5.

In the embodiment depicted in FIG. 4, the STP stream 204 is interpreted by the STP interpreter 205 running on the host device processor 21. The STP interpreter 205 uses the rendering hardware 16 to generate bitmap images according the visual objects described by the STP stream 204. The bitmap objects are transferred 206 to the Frame Buffer 5 using the bus 13.

Various layers of the architecture will now be described. At a top layer, native applications written expressly for the SVE generate graphical information in the STP. Legacy applications correspond to older applications, such as those written using OpenGL, are executed and their OpenGL calls are echoed to and interpreted by an OpenGL-compliant component of the API layer 201.

At the API layer of the architecture, spatial processing is performed. The API layer comprises one or more modules, potentially including a standardized graphical user interface, compatibility libraries for existing standards (for example, OpenGL and Direct3D), and rendering libraries that expose specialized functionality of spatial displays. One component of the API layer is a volume manager. When an application needs to draw in a 3D display, the application requests region(s) from the volume manager. A handle to the region is passed back, and the application may draw into that region. For example, if the user wants to depict a clock that floats in 3D as well as a complex molecule, each entity would exist in its own region. The position and size of each region are managed by the volume manager. The volume manager issues handles to spatial regions, merges 3D imagery/text from all applications, and then outputs the final state of the 3D display, via STP, to an STP-compliant device or set of devices.

The 3D GUI also includes an input device manager (3D mouse, gloves). The input device manager keeps track of the position of cursors, mouse pointers, glove/haptic interfaces, etc. Further, the 3D GUI includes a widget manager. A “widget” refers to standard display elements such as slider bars, quit/minimize/maximize icons, and text-entry fields. The widget manager includes a library of widgets available for use by the application developer.

The API layer further includes a spatial toolkit that provides a group of utilities and functions that interpret, process, and enhance data. A volume rendering toolkit provides functions that enhance visualization of volume datasets. Typical functions include: smoothing, histogramming, mapping data to color or symbol, and polygonalizing. Application-specific functions may be provided, as well. Examples of application-specific functions in the field of medical imaging include reading PET, CT, and MRI data in formats such as DICOM. The spatial toolkit may include an OpenGL interpreter that converts OpenGL calls to an STP compliant format and a DirectX interpreter that converts Direct3D calls to an STP compliant format. The spatial toolkit may also include image manipulation utilities (such as 3D screenshot, image enhancement, or text annotation).

The API layer of the architecture may also include applications that provide low-level graphics functions such as draw line, draw triangle, etc.

The STP output layer 203 generates the STP-formatted graphical information such that an STP-compliant display can show the 3D scene that is dictated by the volume manager.

A display layer includes the STP interpreter 205 which, depending on system configuration, may be implemented in the host device, which then sends device-level instructions to a 3D or 2D display. In one embodiment, the host device takes triangle-level descriptions of a geometric scene and decomposes them into regions that intersect the positions of the spatial display's rotating screen. Those regions are sent to the spatial displays output device's embedded controller 14. The process of decomposing triangle-level descriptions is described in U.S. patent application U.S. 20020105518A1, “Rasterization of polytopes in cylindrical coordinates.”

As discussed above, the display layer may also provide embedded processing. The spatial display, typically a volumetric, stereoscopic, or holographic display, may contain an embedded controller that transforms device-level instructions into a 3D or 2D image. For example, in one embodiment, the decomposed regions are scan-converted or rasterized in an embedded controller and stored in 3 Gbits of RAM. This RAM resides in frame buffer 5 or 15.

The display layer also includes the spatial display itself which is a 3D display device. In one embodiment, rasterized data is projected into 3D by projecting 5,000 images per second onto a rotating diffuse projection screen. The display device may contain input devices such as a touch screen or viewer-position sensor. Although the sensors are physically located on or near the display, their signals would be read by the application layer or the 3D GUI layers.

In implementation, the computation of the STP-formatted graphical data may be balanced between a host device(s) and the display device, which normally contains an embedded computer. Multiple host devices can drive a single display. There may be multiple heterogeneous host devices, optionally coupled through a gateway host device. That is, several devices can communicate with a volume manager implemented in a gateway host device in order to use display space. Displays and hosts can be local or remote. A display can be physically in a different geographical location than a host; STP acts as the communication protocol.

The spatial transport protocol describes the interaction between the SVE and a spatial display's specific rendering system. The spatial transport protocol comprises a set of commands. The STP may optionally comprise a physical definition of the bus used to communicate STP-formatted information. The STP commands are divided into several groups. One group of commands is for operating the rendering hardware, and frame buffer associated with the display. Another group of commands is for synchronizing the STP command stream with events on the host device, rendering hardware and frame buffer. Another group of commands is for operating features specific to the display hardware, such as changing to a low power mode or reading back diagnostic information.

Different streams of graphics commands from different applications may proceed through the architecture to be merged into a single STP stream. Due to multitasking, the STP is able to coherently communicate overlapping streams of graphics commands. STP supports synchronization objects between the applications (or any layer below the application) and the display hardware. The application level of the system typically generates sequential operations for the display drivers to process. Graphics commands may be communicated with a commutative language. For efficiency, the display hardware completes the commands out of order. Occasionally, order is important; one graphics operation may refer to the output of a previous graphics operation, or an application may read information back from the hardware, expecting to receive a result from a sequence of graphics operations.

A standard set of 3D GUI components permit applications to easily communicate common idioms. By standardizing the 3D GUI components, a visual language is developed to which users will quickly grow accustomed. Some idioms of standard 2D window managers are redefined to provide view-direction-independent widgets for the 3D display. Buttons are represented as small geometric objects (e.g., spheres or cubes). Most dialog windows on 2D screens provide a choice between an action and canceling the action (load a file or cancel; continue installation or cancel). The 3D GUI provides standard color and shape coding for these commonly used buttons, reducing the need for a legible text label. Button boundaries can be relaxed along the preferred view direction to help “mousing” in the depth direction. Due to the 3D display, it may not be as easy to perceive mouse pointer depth as pointer height or lateral position.

A 3D pointer is significantly more functional than a pointer on a flat screen. The natural human ability to indicate a relevant part of a complex scene (with a pointing finger, for example) is frustrated on a flat picture, where depth information has been lost. Nevertheless, a 3D pointer must still cope with the limitations of human viewers in sensing depth. If a pointer were represented by a floating point or a small icon than can be translated around, it might not be possible to tell the depth of the point relative to the object in a quick glance. An arrow with a trailing line segment would be more expressive and easier to interpret at a glance. Although the arrow would require six degrees of freedom to be fully specified, the arrow tail may follow the direction of pointer movement. Then, the user need only specify a 3D position and a path to that position.

The volume manager 202 coordinates the display activity of the set of running applications. Volume manager 202 permits applications that are written without knowledge of each other to operate together in the limited volume of a spatial display. When applications supply more information than can be represented on the display, the volume manager 202 distinguishes between active and inactive information parts. To generate a meaningful presentation, the volume manager devotes the majority of the display resources to the active information parts. The volume manager permits a user or application to influence whether an information part is active or inactive.

The volume manager 202 takes input from applications, other SVE API modules, and from human interface devices, such as a keyboard, mouse, joystick, motion tracker, or 3D pointing device. The volume manager 202 output is directed through the STP output layer 203.

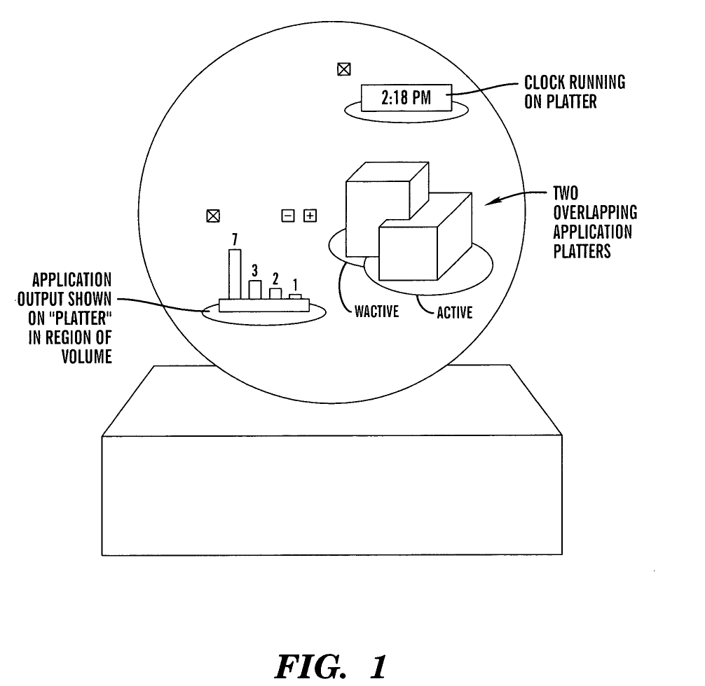

One or more applications can produce output that is projected into the 3D display. 3D graphical information may be presented in output regions referred to as platter examples of which are shown in FIG. 1. A 3D display can present one or more areas of information as attached to platters within a 3D display.

In 3D graphical displays, the addition of the third dimension makes a volume manager function differently than a 2D window manager. Items routinely displayed on 2D display may be difficult to display on a 3D display. For example, although the data in a platter can be viewed from any side, a text title for the platter will be illegible when viewed from the side. For direction-dependent information, such as text, the volume manager 202 uses a preferred viewer position to display the information in a manner viewable by the user. The user may designate a preferred viewing position manually through 3D input device. Alternatively, the spatial display is associated with a sensor to determine the actual viewer position, and the volume manager 202 would coordinate the view-direction-dependent data with readings from this sensor. Alternatively, view-sequential or holographic spatial 3D displays can render text that is always oriented properly for a variety of viewer locations. Examples of view-sequential displays are taught in U.S. Pat. No. 5,132,839, “Three dimensional display device” (A. R. L. Travis) and A View-Sequential 3D Display, Master's thesis, MIT Media Laboratory, September 2003 (0. S. Cossairt). An example of a holographic spatial 3D display is described in “Real-Time Display of 3-D Computed Holograms by Scanning the Image of an Acousto-Optic Modulator,” SPIE Vol. 1136—Holographic Optics II: Principles and Applications, pp. 178-185 (1989) (J. S. Kollin, S. A. Benton, and M. L. Jepsen).

FIG. 1 depicts an exemplary 3D display with a number of platters corresponding to a region within the 3D display area. Each platter can be moved (e.g., dragged using 3D input device), maximized, minimized, or closed. Actions of this sort are illustrated in FIG. 1, as +, −, and X. If two platters have regions that intersect each other, one can be rendered as an “active” platter. The graphical data associated with the inactive platter would not be generated in the region occupied by the active platter 100.

It is possible to eliminate the overlapping platter problem by disallowing that case. The volume manager 202 automatically provides an allocation of space between the applications, which the user can adjust. The volume manager 202 also supports complicated automatic actions. If the preferred (or sensed) viewer direction changes, the allocation of space within the 3D display automatically shuffles to maintain a sensible display for the user. Inactive platters may be entirely removed from the display volume, partially obscured by active platters, or the volume manager may depict inactive platters in a simplified, iconic, or reduced-size form.

A user or application may activate more platters than can be reasonably represented in a spatial display. The volume manager 202 may permit these operations by automatically deactivating one or more of the platters that were previously being displayed. The volume manager. 202 presents the active visual objects in the most dominant part of the display's volume.

Selection among the displayed inactive platters is a common user activity. For example, a user may compare the contents of two platters that cannot be simultaneously displayed. The volume manager 202 may reserve a region of the display volume to represent inactive platters to facilitate selection among them. The volume manager 202 may distinguish the region of inactive platters by placing it near the back of the display, relative to the preferred viewing direction. This emphasizes the active platters while allowing a user to quickly find inactive platters. Depth perception allows the user to distinguish between active platters and the inactive platter region.

As described above, the present invention can be embodied in the form of computer-implemented processes and apparatuses for practicing those processes. In an exemplary embodiment, the invention is embodied in computer program code executed by the server. The present invention may be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A system for displaying graphical information in three dimensions, the system comprising:
a host device executing an application for generating graphical information in a spatial transport protocol;
rendering hardware for generating three-dimensional display data;
frame buffer for storing said three-dimensional display data;
a spatial display for displaying said three-dimensional display data; and
a spatial transport protocol interpreter receiving said graphical information in said spatial transport protocol and controlling operation of said rendering hardware and said frame buffer in response to said graphical information in said spatial transport protocol.

2. The system of claim 1 wherein:
said rendering hardware, said frame buffer and said spatial transport protocol interpreter are incorporated within said spatial display.

3. The system of claim 2 wherein:
said host device is coupled to said spatial display by a bus.

4. The system of claim 1 wherein:
said rendering hardware, said frame buffer and said spatial transport protocol interpreter are incorporated within said host device.

5. The system of claim 1 wherein:
said rendering hardware generates a bitmap image.

6. The system of claim 1 wherein:
said rendering hardware generates a vector list.

7. The system of claim 1 wherein:
said spatial transport protocol includes commands.

8. The system of claim 7 wherein:
said commands include commands for operating said rendering hardware and said frame buffer.

9. The system of claim 7 wherein:
said commands include commands for synchronizing operation of said host device, said rendering hardware and said frame buffer.

10. The system of claim 7 wherein:
said commands include commands for controlling operation of said spatial display.

11. The system of claim 1 wherein:
a 3D pointer is rendered in said spatial display.

12. The system of claim 11 wherein:
said 3D pointer is rendered as a glyph with a tail, a direction of said tail following a most recent movement of said 3D pointer.

13. An architecture for displaying graphical information in three dimensions, the architecture comprising:
an application layer including applications for generating visual object descriptions;
an application program interface layer receiving said visual object descriptions and generating graphical information;
a spatial transport protocol layer for converting said graphical information into a spatial transport protocol and generating a stream of said graphical information in said spatial transport protocol; and
a display layer receiving said stream of graphical information in said spatial transport protocol and displaying said three-dimensional display data on a three-dimensional spatial display.

14. The architecture of claim 13 wherein:
said application layer includes a native application generating graphical information in said spatial transport protocol.

15. The architecture of claim 13 wherein:
said application layer includes a legacy application generating graphical information that is converted to said spatial transport protocol by said spatial transport protocol layer.

16. The architecture of claim 13 wherein:
said application program interface layer interprets said visual object descriptions formatted in a first format.

17. The architecture of claim 16 wherein:
said first format is OpenGL.

18. The architecture of claim 16 wherein:
said first format is Direct3D.

19. The architecture of claim 13 further comprising:
a volume manger in communication with said application program interface layer, said volume manager managing three-dimensional regions within said spatial display and allocating at least one three-dimensional region to display graphical information from at least one of said applications.

20. The architecture of claim 19 wherein:
said volume manager accesses a preferred viewer position and controls orientation of graphical information within one of said regions in response to said preferred viewer position.

21. The architecture of claim 20 wherein:
wherein said preferred viewer position is specified by a user.

22. The architecture of claim 20 wherein:
wherein said preferred viewer position is detected by a sensor.

23. A volume manager in communication with an application program interface layer, said volume manager managing three-dimensional regions within a three-dimensional spatial display and allocating at least one three-dimensional region to display graphical information from at least one application in communication with said application program interface layer.

24. The volume manger of claim 23 wherein:
said volume manager accesses a preferred viewer position and controls the orientation of graphical information within one of said regions in response to said preferred viewer position.

25. The volume manger of claim 24 wherein:
wherein said preferred viewer position is specified by a user.

26. The volume manger of claim 24 wherein:
wherein said preferred viewer position is detected by a sensor.

27. The volume manager of claim 23 wherein:
visual objects within said spatial display are distinguished from each other by displaying a platter beneath each visual object.

28. The volume manager of claim 27 wherein:
said platter is repositioned within said display through a click-and-drag operation on said platter.

29. The volume manager of claim 27 wherein:
said platter is associated with an icon, selection of said icon setting the visual object to an inactive state.
